(19) United States
(12) Patent Application Publication
(10) Pub. No.: US 2016/0294629 A1
(43) Pub. Date: Oct. 6, 2016

(54) PLUGGABLE GATEWAY FOR MULTIPLE COMMUNICATION MODULES

(71) Applicant: TRUSTED SOLUTIONS CORPORATION, New Taipei City (TW)

(72) Inventors: An Kuo MAO, New Taipei City (TW); Kuang Hung CHENG, New Taipei City (TW)

(21) Appl. No.: 14/675,221

(22) Filed: Mar. 31, 2015

(51) Int. Cl. H04L 12/24

(52) U.S. Cl. CPC H04L 41/12

(57) ABSTRACT

A pluggable gateway for multiple communication modules comprises a modulated frame, having at least one modulated slot portion, a front end of the modulated slot portion being an open window portion; and a modulated circuit device, disposed in the modulated frame and having a circuit board portion that has a processor and a micro controller; wherein an insertion portion is disposed corresponding to the modulated slot portion and electrically connects with the processor, the micro controller or the circuit board portion. A pluggable gateway for multiple communication modules provides a plurality of modules for flexible applications and uses the way of pluging/unpluging to change different types of communication modules without dismantling case, so as to be customer-demand, serve to different systems of Internet of Things and easy upgrade.

### BACKGROUND OF THE INVENTION

1. Field of the Invention

The present invention generally relates to a gateway, more particularly to a pluggable gateway for multiple communication modules that is to modularize IP sharing device or router and with flexible applications, convenient upgrade and cost-effective.

2. Description of the Prior Art

According to the popularization of the Internet, data transmission via the Internet has become a part of people's daily life or work. In order to make a plurality of user ends of a region end, such as home or office, to connect with the Internet by means of network communication devices, such as mobile phone, laptop or desktop computer, etc. for browsing information, uploading information, downloading data, communications, etc., those operations are to set up an IP sharing device (or router) in the region end, in order to achieve the purpose of sharing resources. As shown in FIG. 1, illustrates a schematic structural view of a local network in prior arts, and an ADSL line 82 connects with an IP sharing device 80 through a modem 81. The IP sharing device 80 system can be connected to a wired computer 83; on the other hand, the IP sharing device 80 is also able to wirelessly connected with a computer 84 and a laptop computer 85, such as WiFi, for the conduct of the computers 83, 84, the laptop computer 85, etc. while using an Internet IP simultaneously.

With reference to FIG. 2 and FIG. 3, which illustrate a schematic circuit system view of a broadband gateway in prior arts and a schematic system view of another broadband gateway in prior arts. The IP sharing device 80 mainly comprises a motherboard 90 that has a CPU 87 and is embedded in (designed in CPU) or externally connected with (designed in motherboard) more than one internet chip, wherein the internet chip has two types of wired internet chip and wireless internet chip 84.

In order to make the wireless internet chip 84 be with the flexibility of manufacturing and design, the wireless internet chip and the circuits are integrated into a module. The wireless internet chip and the circuits are connected with each other via PCI-E, internal high-speed communication interface, etc., which are not limited thereto. Besides, through those internal high-speed communication interfaces, a specific wireless internet line 86 is embedded in or externally connected with the motherboard 90, wherein the external connection adopts socket or welding. At last, a whole product is sold to client after sealing case.

The IP sharing device as aforesaid still has some shortcomings even its structure is able to share communications with wired and wireless local networks. For example, the CPU 87, related chips and firmware in the IP sharing device 80 are welded on the motherboard 90, so that those original hardware and software of the IP sharing device 80 are hardly changed. If upgrading the wireless internet chip 84 with IEEE 802.1b communication chip module (11 Mbit/s, 2.4 GHz) to another wireless internet chip with IEEE 802.1g communication chip module (54 Mbit/s, 2.4 GHz), the original single wireless internet chip 84 with IEEE 802.1b communication chip module cannot directly changed, and therefore the whole IP sharing device 80 must be changed, so that the design is not with business considerations. More, another type of prior IP sharing device is to uniquely embed chip or firmware in itself by means of welding or other fastening, and hence it is still with such shortcomings.

An extension application for the Internet is Internet of Things (IoT) developed by Semantic Web. Internet of Things (IoT) that is material objects connected to the Internet and is an important industry in the future development path. In practice, a specific object is stuck a micro sensing chip, which is radio frequency identification (RFID) chip, sensor, wireless communications chip, etc. Through various communications, wired and wireless, exchanges of things, dialogues between human being and things, interpersonal dialogues, etc. are approached. Hence, equipment everywhere can be intellectual for integrating management and services. Presently there are four systems for IoT and listed below: AllSeen, HomeKit, Thread Group and OIC, but those are compatible. Accordingly, current IP sharing device/router is not applied to IoT, and is necessary to be improved for conforming to the requirements of IoT. Therefore, how to improve such product is an important issue for the people skilled in the art.

Consequently, the inventor of the present invention has studied related arts in order to produce a solution, which is a pluggable gateway for multiple communication modules. Hopefully, the present invention features flexible applications, convenient upgrade and cost-effective, so as to serve people and societies.

### SUMMARY OF THE INVENTION

The main objective of the present invention is to provide a pluggable gateway for multiple communication modules and a plurality of modules for flexible applications. As a matter of fact, it is customer-demand for choosing applications and setup operations, and upgrades by means of network transmission, so as to reach the goal of flexibility and efficiency.

The other objective of the present invention is to provide a pluggable gateway for multiple communication modules and gateways to have the applications of Internet of Things and other system networks, and has a contingency reserve function for switching different types of Internet of Things in order to improve application fields and features.

To reach above objectives, the present invention comprises: a modulated frame, having at least one modulated slot portion, a front end of the modulated slot portion being an open window portion; and a modulated circuit device, disposed in the modulated frame and having a circuit board portion that has a processor and a micro controller; wherein an insertion portion is disposed corresponding to the modulated slot portion and electrically connects with the processor, the micro controller or the circuit board portion.

Accordingly, the modulated frame (10) has a front plate (13), and the window portion (12) is on the front plate (13).

Accordingly, the circuit board portion has a first circuit board and a second circuit board electrically connected with each other, the first circuit board is on a bottom plate of the modulated frame, the second circuit board is on a rear plate of the modulated frame, the processor and the micro controller are disposed on the first circuit board, the insertion portion is disposed on the second circuit board.

Accordingly, the pluggable gateway for multiple communication modules further comprises a power supply module that electrically connects with the processor.

Accordingly, the modulated slot portion is inserted a communication module.

Accordingly, the communication module is a wireless LAN module, a Bluetooth module, a ZigBee module, a mobile communication module, a wired communication module, a NFC module, an RFID module, a Z-wave module, or an infrared module.

Accordingly, the wireless LAN module is defined by the IEEE 802.11 wireless network communications standards or amendments to the standard series of the International Institute of Electrical and Electronics Engineering (IEEE).

Accordingly, the communication module has at least one antenna.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic structural view of a local network in prior arts;

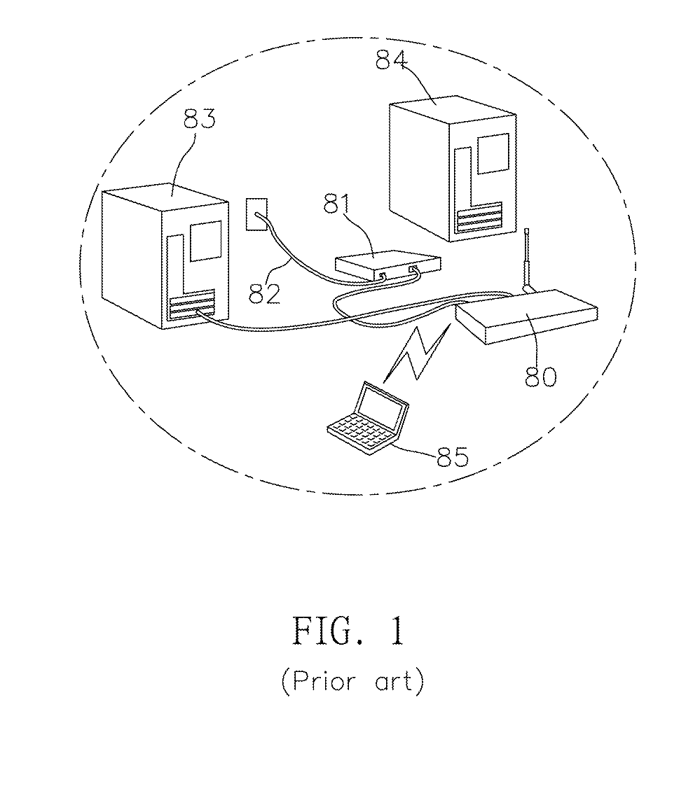

FIG. 2 illustrates a schematic circuit system view of a broadband gateway in prior arts;

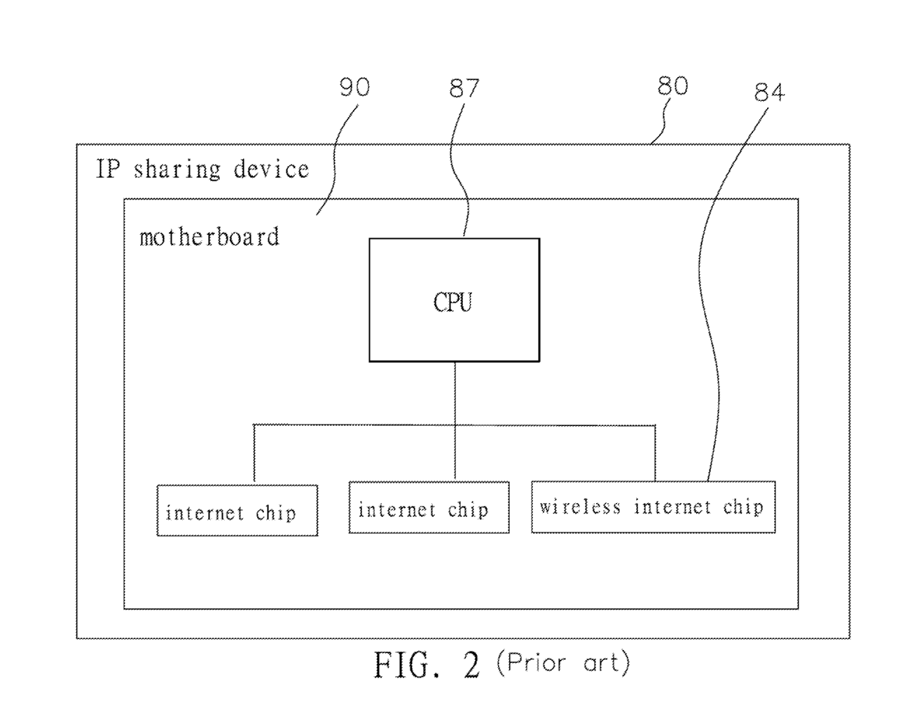

FIG. 3 illustrates a schematic system view of another broadband gateway in prior arts;

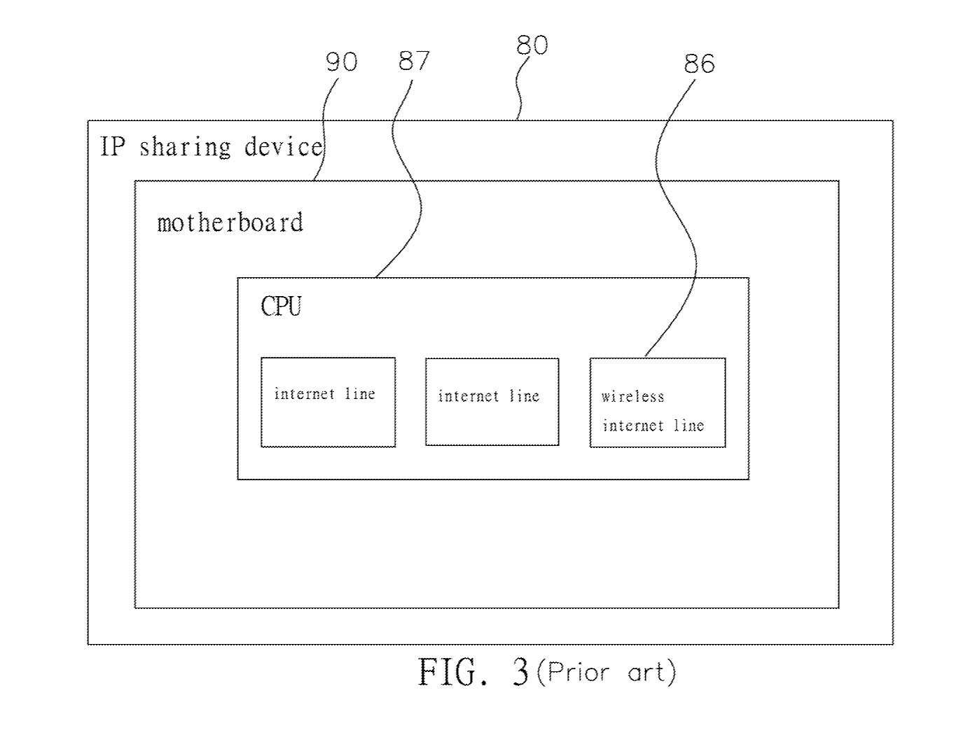

FIG. 4 illustrates a schematic structural view of the present invention; and

FIG. 5 illustrates a schematic circuit system view of the present invention.

### DETAILED DESCRIPTION OF THE PREFERRED EMBODIMENTS

Following preferred embodiments and figures will be described in detail so as to achieve aforesaid objects.

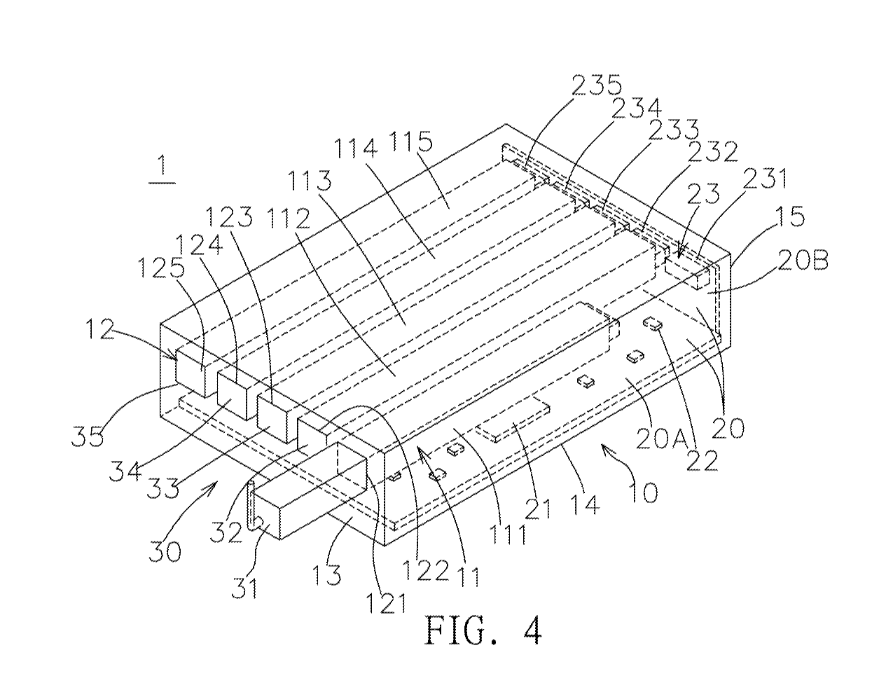

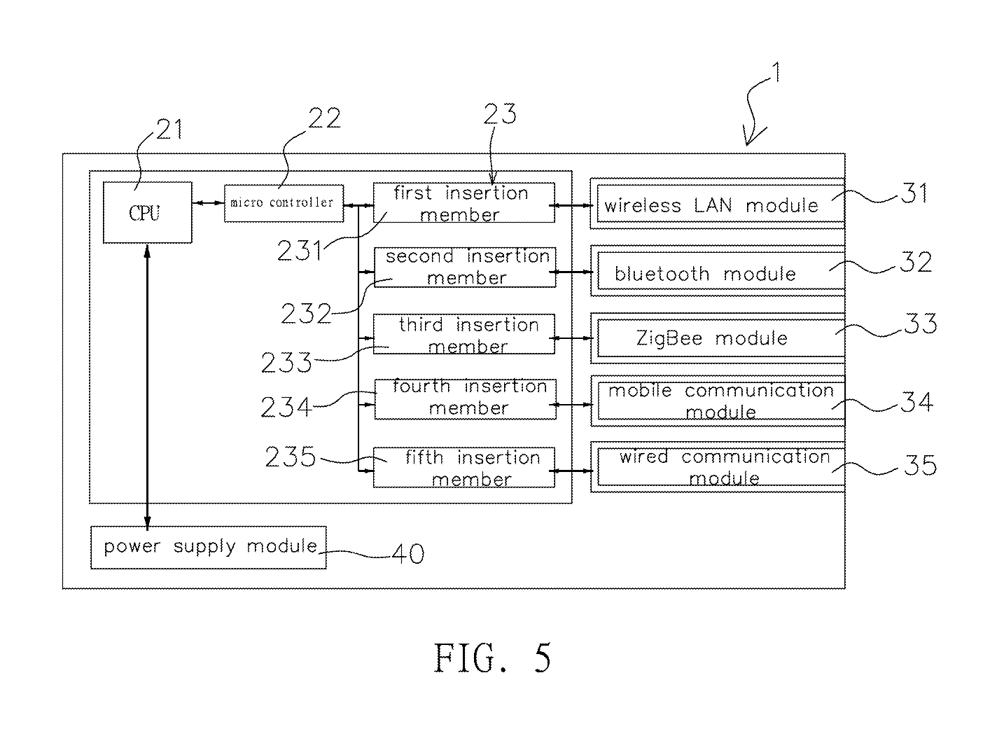

Please refer to FIG. 4 and FIG. 5. As shown in figure, the pluggable gateway for multiple communication modules is a modulated gateway 1, which has a modulated frame 10 and a modulated circuit device 20. The modulated frame 10 has a modulated slot portion 11 with at least one modulated slot. As shown in the embodiment, the modulated slot portion 11 has a first modulated slot 111, a second modulated slot 112, a third modulated slot 113, a fourth modulated slot 114, and a fifth modulated slot 115, and the number of the modulated slot is not limited thereto. According to the direction of the figures, the front end of the modulated slot portion 11 is an open window portion 12; in other words, the front ends of the first modulated slot 111, the second modulated slot 112, the third modulated slot 113, the fourth modulated slot 114, and the fifth modulated slot 115 are correspondingly disposed a first window 121, a second window 122, a third window 123, a fourth window 124, and a fifth window 125. Preferably, the first window 121, the second window 122, the third window 123, the fourth window 124, and the fifth window 125 are disposed on a front plate 13 of the modulated frame 10.

The modulated circuit device 20 is disposed in the modulated frame 10 and has a circuit board portion. As shown in the embodiment, the circuit board portion has a first circuit board 20A and a second circuit board 20B electrically connected with each other, wherein the first circuit board 20A is on a bottom plate 14 of the modulated frame 10, the second circuit board 20B is on a rear plate 15 of the modulated frame 10. The processor (CPU) 21 and the micro controller 22 are disposed on the first circuit board 20A. The insertion portion 23 is disposed on the second circuit board 20B and electrically connects with the processor 21 and the micro controller 22. The insertion portion 23 has a first insertion member 231, a second insertion member 232, a third insertion member 233, a fourth insertion member 234, and a fifth insertion member 235 that are respectively corresponding to the first modulated slot 111, the second modulated slot 112, the third modulated slot 113, the fourth modulated slot 114, and the fifth modulated slot 115.

In addition, a communication module 30 having an internal chip in order to be inserted into the modulated slot portion 11. For the embodiment, the communication module 30 is a wireless LAN module (WiFi) 31, a Bluetooth module 32, a ZigBee module 33, a mobile communication module 34, or a wired communication module 35 as Ethernet, wherein the wireless LAN module 31 is defined by the IEEE 802.11 wireless network communications standards or amendments to the standard series of the International Institute of Electrical and Electronics Engineering (IEEE), also named 802.11g etc., and generally speaking, its simplified name is WiFi. The Bluetooth module 32 (Bluetooth) is a wireless personal area network technology standard set by the Bluetooth SIG, so as to conduct a short-range wireless data transmission application. The ZigBee module 33 is for a low-speed short-range transmission; the mobile communication module 34 is for the conduct of the mobile phone network applications such as LTE 4G, etc; and the wired communication module 35 (Ethernet) is by Ethernet (Ethernet) LAN networking. As aforesaid, the communication module 30 has at least one antenna, such as the wireless LAN module 31, as shown in FIG. 4.

The plurality of kinds of the communication module 30 as mentioned above are only examples, but are limited thereto; other examples as NFC module, RFID module, Z-wave module, an infrared module, etc. are all possibilities. The modulated gateway 1 further has a power supply module 40 that electrically connects with the processor (CPU) 21 and the micro controller 22, so that the electric connection of the processor (CPU) 21, the micro controller 22, the insertion portion 23, and the communication module 30 is integrated.

Please also refer to FIG. 5. The wireless LAN module (WiFi) 31, the Bluetooth module 32, the ZigBee module 33, the mobile communication module 34, and the wired communication module (Ethernet) 35 are inserted into the first modulated slot 111, the second modulated slot 112, the third modulated slot 113, the fourth modulated slot 114, and the fifth modulated slot 115 via the first window 121, the second window 122, the third window 123, the fourth window 124, and the fifth window 125; hence, the wireless LAN module (WiFi) 31, the Bluetooth module 32, the ZigBee module 33, the mobile communication module 34, and the wired communication module (Ethernet) 35 are electrically connected with the first insertion member 231, the second insertion member 232, the third insertion member 233, the fourth insertion member 234, and the fifth insertion member 235 respectively for each modularization.

In practice, in order to upgrade the modulated gateway 1, as broadband gateway or router, to IEEE 802.1g instead of original IEEE 802.1b of the wireless LAN module 31, a new wireless LAN module 31 with IEEE 802.1g inserted into the modulated gateway 1 simply completes such upgrade without changing the whole gateway for saving cost and efficiency.

Due to the modulated slot portion 11 of the modulated gateway 1 having a plurality of modulated slots with different types of communication protocol or modulations, the present invention applying to different types of Internet of Things (IoT) may have a great effect. More particularly, the present invention is able to use the way of pluging/unpluging to change different types of communication modules without dismantling case. Therefore, the present invention may serve to different systems of Internet of Things with present or future versions, and those objects in the Internet of Things are possible to be compatible.

The present invention is a pluggable gateway for multiple communication modules, and provides a plurality of modules for flexible applications. As a matter of fact, it is customer-demand for choosing applications and setup operations, and upgrades by means of network transmission, so as to reach the goal of flexibility and efficiency. Further, the present invention provides gateways to have the applications of Internet of Things and other system networks, and has a contingency reserve function for switching different types of Internet of Things in order to improve application fields and features.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A pluggable gateway for multiple communication modules, comprising:
a modulated frame (10), having at least one modulated slot portion (11), the modulated slot portion (11) being inserted a communication module (30), a front end of the modulated slot portion (11) being an open window portion (12); and
a modulated circuit device (20), disposed in the modulated frame (10) and having a circuit board portion that has a processor (21) and a micro controller (22);
wherein an insertion portion (23) is disposed corresponding to the modulated slot portion (11) and electrically connects with the processor (21), the micro controller (22) or the circuit board portion.

2. The pluggable gateway for multiple communication modules according to claim 1, wherein the modulated frame (10) has a front plate (13), and the window portion (12) is disposed on the front plate (13).

3. The pluggable gateway for multiple communication modules according to claim 1, wherein the circuit board portion has a first circuit board (20A) and a second circuit board (20B) electrically connected with each other, the first circuit board (20A) being on a bottom plate (14) of the modulated frame (10), the second circuit board (20B) being on a rear plate (15) of the modulated frame (10), the processor (21) and the micro controller (22) being disposed on the first circuit board (20A), the insertion portion (23) being disposed on the second circuit board (20B).

4. The pluggable gateway for multiple communication modules according to claim 1 further comprising a power supply module (40) that electrically connects with the processor (21).

5. The pluggable gateway for multiple communication modules according to claim 1, wherein the communication module (30) is a wireless LAN module (31), a Bluetooth module (32), a ZigBee module (33), a mobile communication module (34), a wired communication module (35), a NFC module, an RFID module, a Z-wave module, or an infrared module.

6. The pluggable gateway for multiple communication modules according to claim 5, wherein the wireless LAN module (31) is defined by the IEEE 802.11 wireless network communications standards or amendments to the standard series of the International Institute of Electrical and Electronics Engineering (IEEE).

7. The pluggable gateway for multiple communication modules according to claim 6, wherein the communication module (30) has at least one antenna.
